(19) United States
(12) Patent Application Publication
(10) Pub. No.: US 2026/0187759 A1
(43) Pub. Date: Jul. 2, 2026

(54) UNSUPERVISED EXTRACTION OF THE MATERIALS HIERARCHY IN MULTI- AND HYPERSPECTRAL REMOTE SENSING IMAGES USING SINGLE-LINK CLUSTERING

(71) Applicant: Saudi Arabian Oil Company, Dhahran (SA)

(72) Inventor: Sabbir Rahman, Dhahran (SA)

(21) Appl. No.: 19/007,912

(22) Filed: Jan. 2, 2025

(51) Int. Cl. G06T 5/50; G06T 5/20; G06T 7/13; G06V 10/25; G06V 10/762

(52) U.S. Cl. CPC G06T 5/50; G06T 5/20; G06T 7/13; G06V 10/25; G06V 10/762; G06T 2207/10036

(57) ABSTRACT

Systems and methods include automatically extracting a complete hierarchy of all key materials present in a multi- or hyperspectral image. A multispectral image corresponding to a region of interest is received. The multispectral image includes aerial images of the region of interest captured by a multispectral sensor. The multispectral image is processed, by applying a multidimensional edge detection filter to remove a portion of the plurality of pixels identified as impure pixels. A remaining portion of the pixels include unmasked samples. A Euclidian minimum spanning tree of unmasked samples is determined. The unmasked samples are rotated to minimize a dimension of the unmasked samples. A single-link clustering is applied to generate a dendrogram of pure materials. An action plan is identified to remedy a risk associated with the dendrogram of pure materials.

### TECHNICAL FIELD

The present disclosure is generally related to material classification and, more specifically, to extraction of a complete hierarchy of materials present in a multi- or hyperspectral image.

### BACKGROUND

Multi- and hyperspectral images include a variety of information about the materials present in a region of interest. Each pixel typically encodes the amount of electromagnetic energy reflected over a wide spectrum of frequencies ranging from infrared to ultraviolet split into tens (in the multispectral case) or even hundreds (in the hyperspectral case) of frequency bands and often with 10-bits of data or more (e.g., 1024 levels or more) in each band. The ability to detect with high fidelity the entire electromagnetic spectrum being radiated at each pixel can in principle allow an analyst equipped with the right analytical tools to extract detailed information regarding the respective material content, and if applied to the entire image, generated an entire library of the spectra associated with each material present in the image. Unsupervised clustering techniques can be generally applicable for high-level analyses failing to extract information from a large majority of the spectra.

### SUMMARY

Implementations of the present disclosure are directed to material classification. More particularly, implementations of the present disclosure are directed to extraction of a complete hierarchy of materials present in a multi- or hyperspectral image.

In some implementations, a method includes: receiving a multispectral image corresponding to a region of interest, the multispectral image including aerial images of the region of interest captured by a multispectral sensor, the multispectral image includes a plurality of pixels, processing the multispectral image, by applying a multidimensional edge detection filter to remove a portion of the plurality of pixels identified as impure pixels, a remaining portion of plurality of pixels including unmasked samples, determine a Euclidian minimum spanning tree of unmasked samples, wherein the unmasked samples are rotated to minimize a dimension of the unmasked samples, applying a single-link clustering to generate a dendrogram of pure materials, and identifying an action plan to remedy a risk associated with the dendrogram of pure materials.

The foregoing and other implementations can each optionally include one or more of the following features, alone or in combination. In particular, implementations can include all the following features:

In a first aspect, combinable with any of the previous aspects, wherein each pixel of the plurality of pixels having an associated spectrum consisting of a plurality of dimensions. In other aspects, combinable with any of the previous aspects, determining the Euclidian minimum spanning tree of unmasked samples includes: ranking the unmasked samples to generate ranked samples, reordering the ranked samples to generate reordered samples, storing locations of the reordered samples, iteratively finding the edges of the Euclidean minimum spanning tree of the reordered samples, and generating the dendrogram including the hierarchy of pure materials corresponding to the reordered samples. Reordering the ranked samples to generate the reordered samples includes radial ordering of the ranked samples in order of increasing distance from an origin. Reordering the ranked samples to generate the reordered samples includes linear ordering of the ranked samples in order of increasing value in a dimension. Determining the dendrogram of pure materials of unmasked samples includes setting up auxiliary arrays including an adjacent auxiliary array, a last point auxiliary array, and a cluster auxiliary array, and using the auxiliary arrays and the edges of the EMST ordered by increasing size to efficiently generate the dendrogram of pure materials. Identifying the action plan includes determining a material movement pattern from the dendrogram, determining a risk associated with a material movement pattern, and generating an alert indicative of the risk associated with the material movement pattern. Identifying the action plan includes activating an equipment to clean or protect the one or more points of interests identified to be affected by the material movement pattern.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification and masking of mixed pixels, facilitating the application of clustering algorithms to pure pixels that represent distinct and homogenous material features. The described approach efficiently removes the noise associated with mixed pixels, providing the advantage of significantly improving the separation of clusters in the feature space, resulting in more precise and stable cluster formation. The cluster formation improvement of the described implementations is particularly significant for density-seeking hierarchical clustering algorithms, such as single-link clustering, which are sensitive to noise, especially in the region between clusters. Another advantage of the described technology is that it ensures that only high-quality, non-mixed pixels are considered at all scales in the image, the segmentation process becoming more robust, producing clearer and more meaningful segmentations that better represent the range of materials in the image. The described technology substantially improves over existing methods in that it retains spectra representing pure materials that lie close to the boundaries of the pure clusters. The described technology provides a valuable tool for accurate multi/hyperspectral image analysis and interpretation with respective myriad applications. Another advantage of the described technology is that the described mapping of materials can trigger automatic operations for systems and machines configured to maintain environmental safety and system operability.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of a multi- or hyperspectral image, according to some implementations of the present disclosure.

FIG. 2B illustrates an example 2-dimensional scatterplot of the first two principal components of the 12-dimensional spectra from image in FIG. 2A, according to some implementations of the present disclosure.

FIG. 2C illustrates an example representation of a combined mixed pixel mask applied to the image in FIG. 2A, according to some implementations of the present disclosure.

FIG. 2D illustrates an example of false color image showing a single selection of a set of pure material clusters, according to some implementations of the present disclosure.

FIG. 2E illustrates example false color scatterplot showing the spectral distributions from a single selection of pure material clusters, according to some implementations of the present disclosure.

FIG. 3A illustrates an example dendrogram encoding, according to some implementations of the present disclosure.

FIG. 3B illustrates an example dendrogram resulting from hierarchical clustering, according to some implementations of the present disclosure.

FIG. 3C illustrates an example single-link clustering, according to some implementations of the present disclosure.

FIG. 4A is a flowchart illustrating an example process for material classification, in accordance with some example embodiments.

FIG. 4B is a flowchart illustrating another example process for calculation of the Euclidean minimum spanning tree, in accordance with some example embodiments.

FIG. 4C depicts a flowchart illustrating an example process for merging of clusters, in accordance with some example embodiments.

FIG. 5 depicts a block diagram illustrating a computing system, in accordance with some example embodiments.

When practical, like labels are used to refer to same or similar items in the drawings.

### DETAILED DESCRIPTION

The following detailed description describes techniques for material classification. More particularly, implementations of the present disclosure are directed to extraction of a complete hierarchy of materials present in a multi- or hyperspectral image. The described implementations provide methods and systems for automatically extracting a complete hierarchy of all key materials present in a multi- or hyperspectral image. The complete hierarchy of all key materials present in a multi- or hyperspectral image is used for the generation of a reference library of ‘endmembers’ which can subsequently be used for image segmentation, materials mapping, classification, and/or anomaly detection.

Some traditional multispectral image processing algorithms include image segmentation to detect a small, discrete number of clusters using a single clustering method. A common clustering method used is the k-means clustering method, whose spectral classes can be more easily identified. While usage of a single clustering method is applicable for high-level analyses (e.g., detection of land use), it does mean that most of the rich information contained in the spectra can effectively remain unused. Other traditional clustering methods can include agglomerative hierarchical clustering algorithms that can be used to derive an entire materials hierarchy from the high-dimensional statistical distribution of raw spectra, which more closely captures the hierarchical structure of materials in nature than can be achieved through a simple partitioning of that space. Due to their computational complexity, hierarchical clustering methods have in practice only been applied to relatively small images with a relatively small number of bands. Traditional implementations include the calculation and storage in memory of all N² D-dimensional Euclidean distances between the pixel spectra and have a time complexity of O(N³), where N is the number of pixels in the image and D is the number of bands. For a medium-sized 1280×1024 pixel image, just storing the distance matrix can use over 0.8 TB of data, which exceeds the capacity of current computing devices.

The techniques described in the present disclosure provide a solution addressing the material classification using a single-linkage clustering algorithm with a theoretically optimal time complexity of O(N²) that does not require storage of the entire distance matrix. The single-linkage clustering algorithm can include the calculation of N(N−1)/2 distances, which can be extremely time-consuming for large images. The result of single-link clustering is the Euclidean minimum spanning tree (EMST), which is a minimum-length connected acyclic graph including nodes as the set of D-dimensional spectra associated with the N pixels, and edges that represent the Euclidean distances between the spectra represented by the nodes it connects. A “dendrogram” can be generated from the EMST. The dendrogram is a binary tree that encodes in a hierarchical format the complete set of materials present in the image. The determined set of materials can be used as a materials reference library for material identification, image segmentation, materials abundance mapping and/or anomaly detection tasks. The generation of the dendrogram from the EMST resulting from single-linkage clustering can be time-consuming for large images. As additional advantages, the described implementations apply a methodology that achieves an optimal time complexity of O(N²) with O(N) storage, perform intelligent preprocessing that renders most of the N(N−1)/2 distance calculations unnecessary, and allows even those that are necessary to often be terminated early, optimize the use of efficient linked-list data structures to significantly speed up generation of both the Euclidean minimum spanning tree and the materials dendrogram by eliminating the need for array reshuffling, and use advanced filters to mask out “impure” pixels, thereby not only improving the quality of the final results, but also significantly reducing the number of pixels that need to be processed which in turn significantly reduces the time complexity of the algorithm. In contrast to traditional hierarchical clustering methods, the described single-link clustering and respective close relatives, such as hierarchical density-based spatial clustering of applications with noise (HDBSCAN), can detect clusters which have complex shape or structure, and unlike other methods do not attempt to impose an unnatural spheroidal shape on natural material distributions. The described approach provides an improvement by minimizing storage requirements and by minimizing computational complexity.

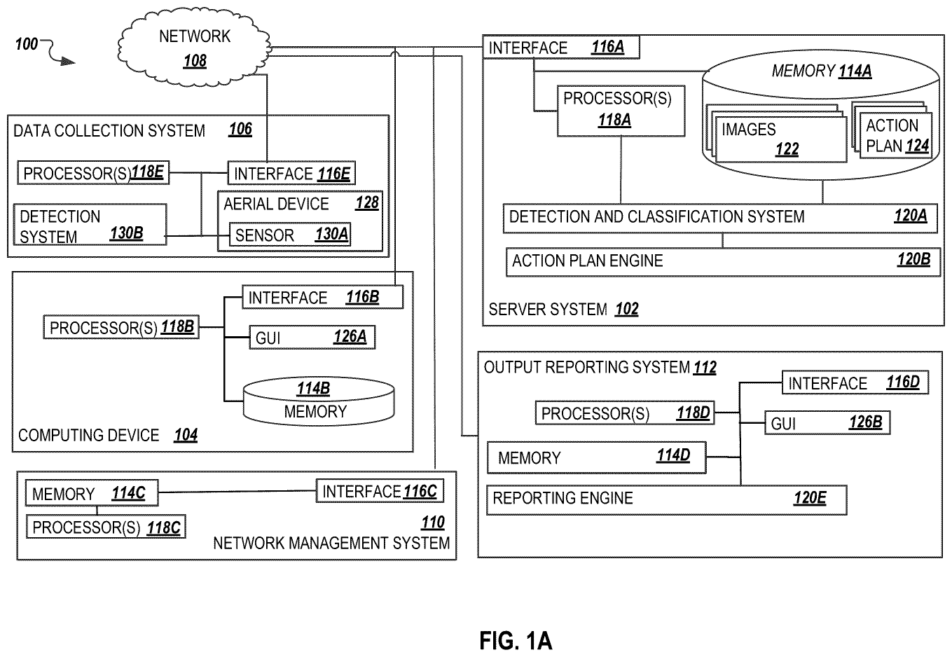

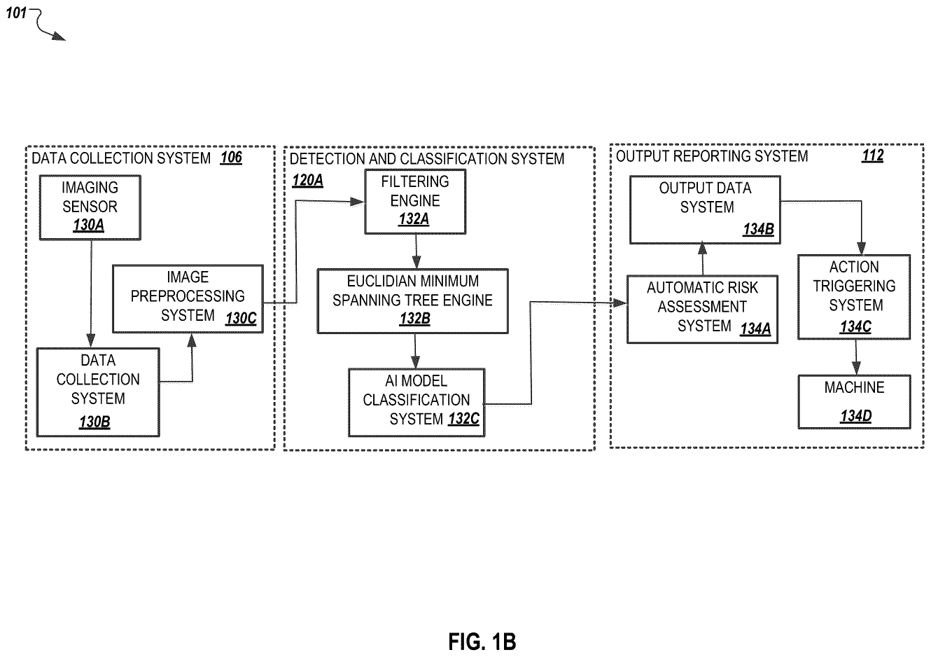

FIG. 1A is a block diagram illustrating an example system 100 that can be used to execute implementations of the present disclosure. For example, example system 100 can be configured to execute clustering algorithms for extraction of a complete hierarchy of materials present in a multi- or hyperspectral image. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages clustering algorithms for unsupervised segmentation of multispectral images. In accordance with implementations of the present disclosure, and as noted above, the server system 102 can host a solution environment that can be a cloud environment providing software applications, systems, and services that can be consumed by customers as a service. In some implementations, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120 and an action plan engine 120B. The memory 114A can include multispectral images 122 and action plans 124. The multispectral images 122 include data measured by and received from the data collection system 106. The multispectral images 122 can include images detected by aerial sensors. The multispectral images 122 can be processed by the detection and classification system 120A to generate material maps that are processed by the action plan engine 120B to generate action plans 124. The action plans 124 in the memory 114A can include action plan documents defining remedial operations performed by systems and machine for management and redistribution of materials.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the material movement patterns. The GUIs 126A, 126B each interface with at least a portion of the example system 100 for any suitable purpose, including generating a visual representation of the multispectral images collected by the data collection system 106, the material maps generated by the server system 102, or data stored by the server system 102, such as multispectral images 122 and action plans 124, respectively. In particular, the GUIs 126A, 126B may each be used to view and adjust various action plans. Generally, the GUIs 126A, 126B each provide the user with an efficient and user-friendly presentation of the material maps and action plans including material movement patterns communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for material movement patterns in addition to key recommended actions for environment and industrial plant safety and continuous operability. The GUI 126B display can facilitate material distribution monitoring and decision makers to modify (operations of) the systems and machines selected for cleaning identified materials.

The data collection system 106 can include multiple imaging sensors 130A and a detection system 130B. The imaging sensors 130A can be within an aerial device 128 (e.g., attached to or included in the aerial device), acquiring samples and data during a flight or hovering operation. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect multispectral images of one or more areas of interest below the aerial device 128. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for material classification. Each processor 118A, 118B, 118C, 118D, 118E executes a functionality required to monitor multispectral images associated to an aerial device 128, to monitor and correct material movement patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., multispectral images and/or dynamic information, and any other appropriate information including material movement pattern models, and any material cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 includes imaging sensors 130A, a data collection system 130B, and an image preprocessing system 130C. The imaging sensors 130A can be coupled to the aerial device 128 and can be displaced to capture multispectral images of multiple regions of interest. The imaging sensors 130A and the detection system 130B are communicatively connected to the processor 118E. The imaging sensors 130A can include red, green blue (RGB) imaging devices, multispectral sensors, and hyperspectral sensors (e.g., infrared imaging spectrometers), or other imaging systems facilitating the collection of multispectral images. The data collection system 130B can generate triggers according to a particular schedule to control data collection executed by the imaging sensors 130A. The data collection system 130B can receive the multispectral images collected by the imaging sensors 130A and transmit them to the image preprocessing system 130C for pre-processing.

The image preprocessing system 130C executes pre-processing of multispectral images that can enhance data quality and can ensure accurate downstream analysis. Pre-processing can include: noise correction to remove sensor noise using correction coefficients during image processing; vignetting correction to address uneven illumination across the image caused by lens vignetting; lens distortion correction to apply distortion models (such as the brown model) to correct lens-induced distortions; band registration to align spectral bands to ensure consistent spatial information; and radiometric correction to normalize pixel values to account for variations in sensor sensitivity. For UAV-based multispectral sensors, these steps optimize data quality, enabling accurate material monitoring and other applications.

The detection and classification system 120A includes a filtering engine 132A, a Euclidian minimum spanning tree engine 132B, and an artificial intelligence (AI) model classification system 132C. The filtering engine 132A applies any of a multidimensional edge detection filter, a multidimensional 9-point Laplacian filter and can generate a volatility map and a locally normalized edge index. The Euclidian minimum spanning tree engine 132B can determine a Euclidian minimum spanning tree of unmasked samples and can generate a dendrogram of pure materials. The AI model classification system 132C can process multiple maps of materials of a particular region, corresponding to multiple time points to generate material variation patterns. The AI model classification system 132C can include machine learning techniques (e.g., neural networks) trained to analyze spatial data and reveal patterns over time.

The output reporting system 112 includes an automatic risk assessment system 134A, an output data system 134B, an action triggering system 134C, and a machine 134D. The automatic risk assessment system 134A can process the material variation patterns and most recently generated maps of materials to determine risks associated to one or more points of interests (e.g., roads, industrial plants, oil drilling and processing systems, etc.). The output data system 134B can include a GUI (e.g., GUI 126 described with reference to FIG. 1A) to generate displays indicating the identified risk. The action triggering system 134C can receive the determined risk, classify the risk (e.g., low, medium, or high) and, based on the classification, generate a trigger to send to the machine 134D to perform a remedial action (e.g., cleaning or relocation of material within the region of interest to protect the one or more points of reference).

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

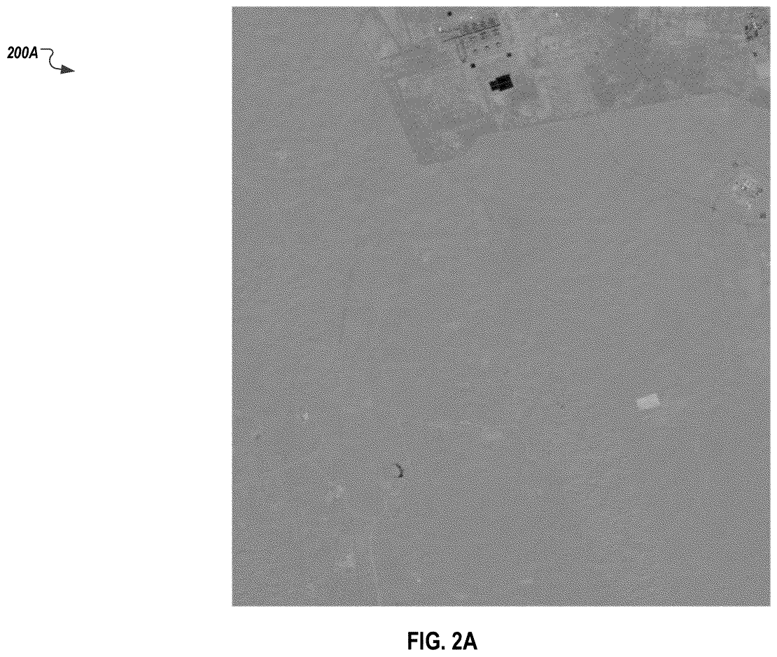

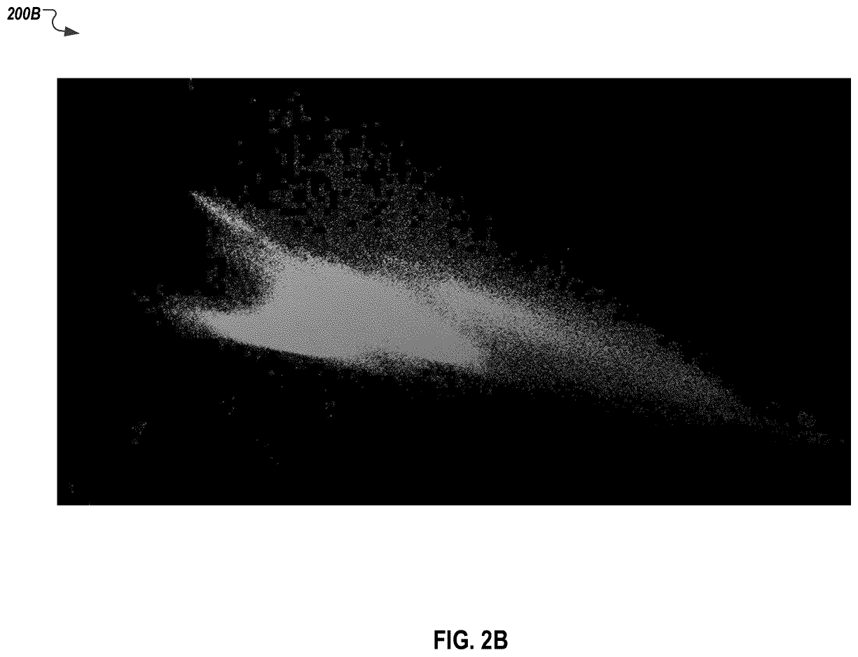

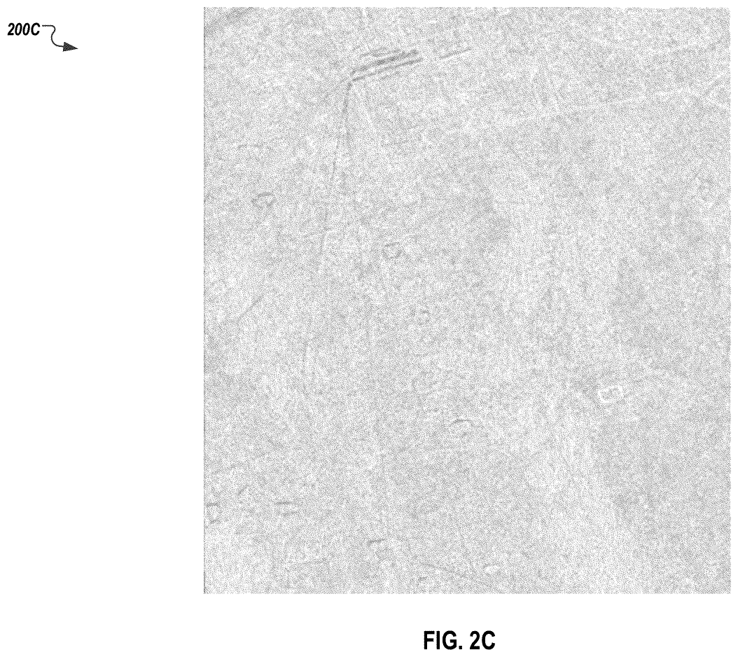

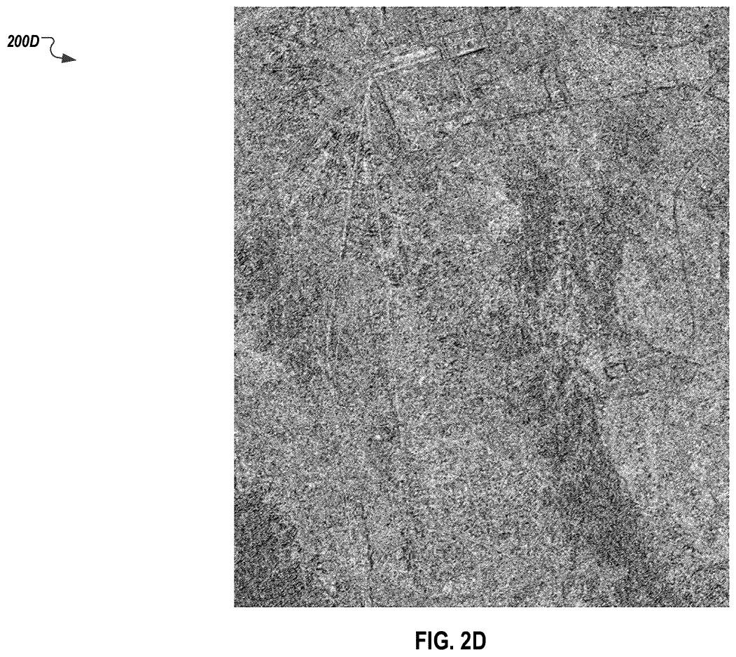

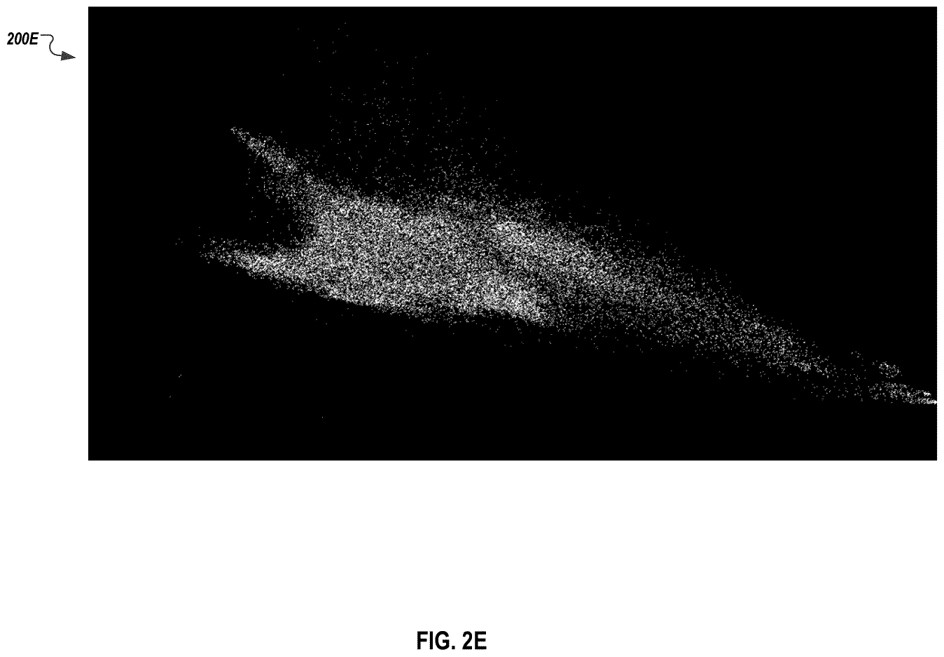

FIG. 2A illustrates an example of a multi- or hyperspectral image 200A, according to some implementations of the present disclosure. The example of a multi- or hyperspectral image 200A can have N=W*H pixels (with width W and height H), with each pixel having an associated spectrum consisting of C “channels” (or “bands”, or “dimensions”). For example, the example of a multi- or hyperspectral image 200A has 1,262×1,533=1,934,646 pixels with 12 bands. The example of a multi- or hyperspectral image 200A can be captured by multispectral sensors that generate data in a few wavelength bands (e.g., 3 to 10 bands), such as red, green, blue, near infrared, and short-wave infrared. The bands can have descriptive titles and a spatial resolution of 30 meters (except for a few particular bands). The example of a multi- or hyperspectral image 200A can help identify land cover, vegetation health, oil spills, sand encroachment, and water quality. The example of a multi- or hyperspectral image 200A can include hyperspectral imagery to provide detailed spectral information, facilitating identification of particular materials and respective unique signatures.

FIG. 2B illustrates example 2-dimensional scatterplot 200B of the first two principal components of the 12-dimensional spectra from image in FIG. 2A, according to some implementations of the present disclosure. The example 2-dimensional scatterplot 200B can include a set of spectra associated with the pixels that can be represented as vectors in a 12-dimensional space, where materials with similar spectra can form clusters of high density. Every point in the example 12-dimensional scatterplot 200B can correspond to the spectrum of a vector associated with a pixel in the example of a multi- or hyperspectral image 200A, described with reference to FIG. 2A.

FIG. 2C illustrates an example combined mixed pixel mask image 200C with a particular edge percentage (e.g., 50%) of edges (shown in yellow) and a particular percentage (e.g., 1%) of subpixel anomalies (shown in in purple) removed, according to some implementations of the present disclosure. The example combined mixed pixel mask image 200C illustrates results of combined mixed pixel mask used to remove mixed pixels which occur both as edges at the border of two or more materials or as subpixel anomalies where a subpixel object distorts the spectrum of the surrounding material in a given pixel.

FIG. 2D illustrates an example of false color image 200D showing a single selection of a set of pure material clusters, according to some implementations of the present disclosure. The example of false color image 200D can be generated after the clustering process was completed. The example of false color image 200D can illustrate clusters associated with materials of interest that can either be selected manually or through an automated material selection process.

FIG. 2E illustrates example false color scatterplot 200E showing the spectral distributions a single selection of pure material clusters, according to some implementations of the present disclosure. The example false color scatterplot 200E D can be generated after the clustering process was completed. The example false color scatterplot 200E can illustrate clusters associated with materials of interest that can either be selected manually or through an automated material selection process.

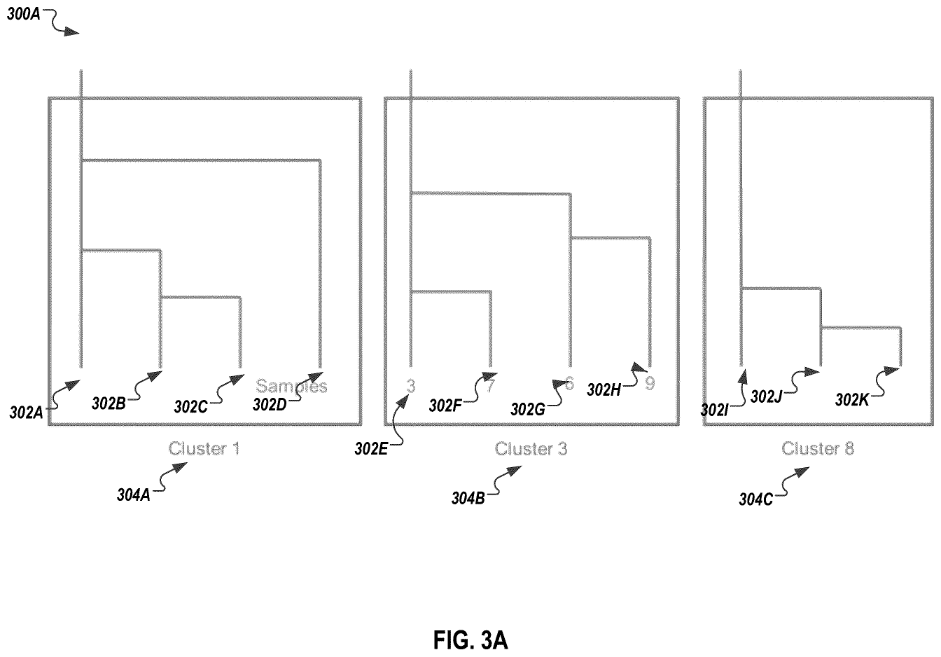

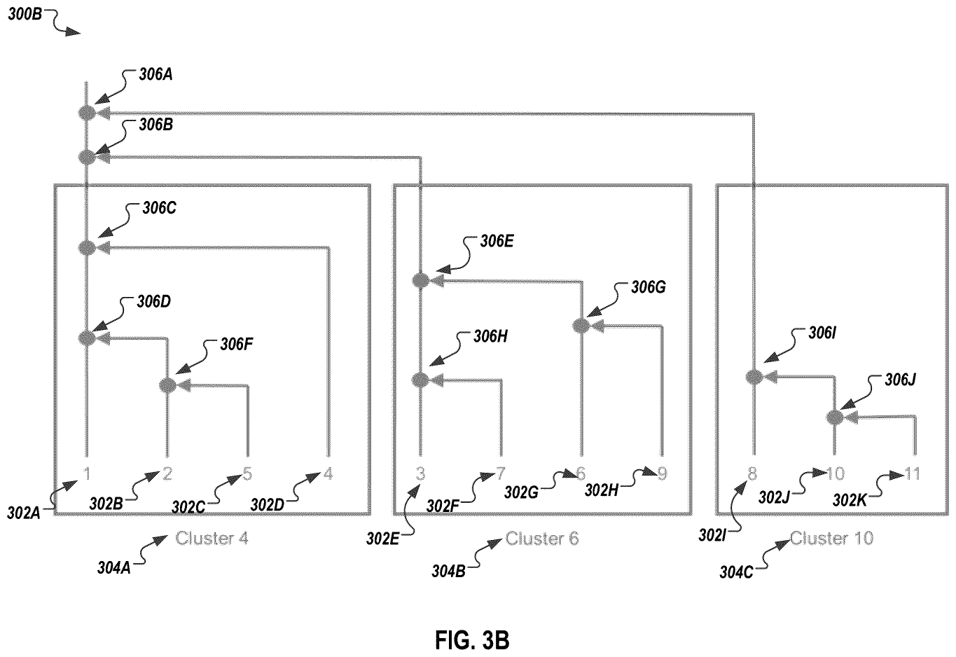

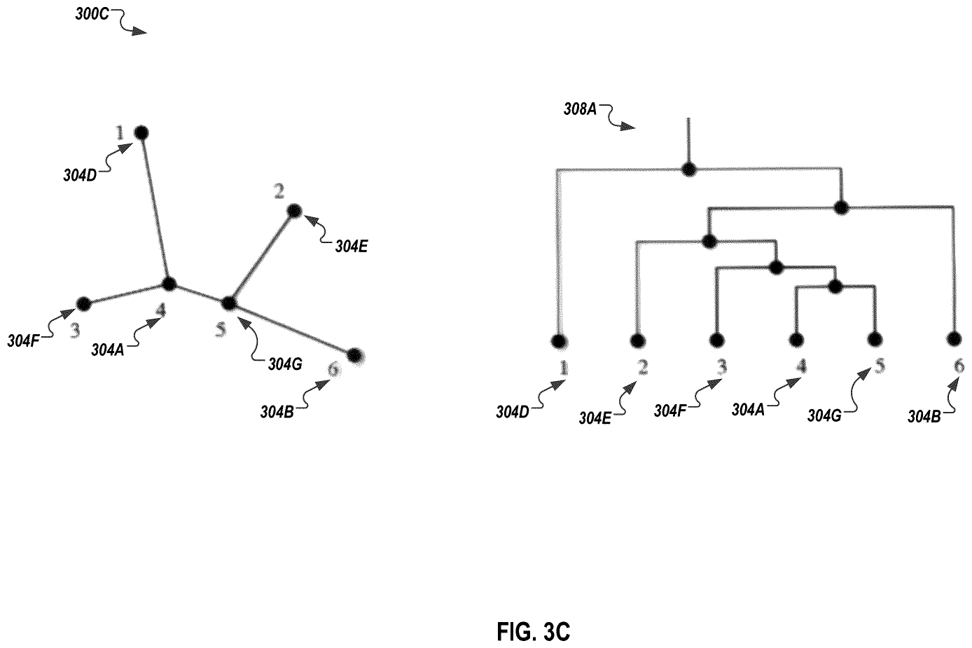

FIG. 3A illustrates an example dendrogram encoding 300A, according to some implementations of the present disclosure. The example dendrogram encoding 300A can be generated by using auxiliary arrays to encode the dendrogram. The example dendrogram encoding 300A includes multiple samples 302A-302K grouped in multiple clusters 304A-304C. In the illustrated example, Cluster 3 304B contains the four data samples 3, 7, 6, and 9 302E-302H, such that clustsize(3)=4 and clust(3)=clust(7)=clust(6)=clust(9)=3 and lastpoint(3)=9. The example dendrogram encoding 300A indicates some samples being adjacent to other samples. For example, sample 9 is adjacent to sample 6 (adjacent (9)=6), sample 6 is adjacent to sample 7 (adjacent (6)=7), sample 7 is adjacent to sample 3 (adjacent (7)=3), and sample 3 having no preceding sample can be denoted as adjacent (3)=−1. Also, Cluster 1 precedes Cluster 3 while Cluster 8 follows it, being denoted as prevclust(3)=1 and nextclust(3)=8.

FIG. 3B illustrates an example dendrogram 300B resulting from hierarchical clustering, according to some implementations of the present disclosure. In the example dendrogram 300A each leaf node 306A-306J corresponds to a sample 302A-302K in the original data set, and is encoded in the arrays tree(i) and pix(i). For example, leaf node 3 can correspond to sample 5, such that tree(5)=3 and pix(3)=5. Each non-leaf node in the binary tree corresponds to the cluster 304A, 304B, 304C containing all of the samples (e.g., leaf nodes) 302A-302K beneath it, and is numbered according to the sample that ‘joins’ to it. For example, a node 306E above sample 3 302E in the central box is cluster 6 304B that contains samples 3, 7, 6 and 9, that are joined as join (6)=3 and that clustsize (6)=4. The joining height is stored in height(6). For a cluster 6 that is formed of a cluster 9 merged with cluster 7 an updated cluster is generated such that clust1size(6)=clustsize (7)=2 and clust2size(6)=clustsize (9)=2. In the illustrated example, cluster 8 contains all eleven samples with join (8)=1. The first sample in the dendrogram (in this case sample 1) does not join to any other sample (represented by join (1)=1) and so does not correspond to a cluster. Each leaf node corresponds to a single-sample cluster. The cluster number can be equal to the sample index+N, where N is the total number of samples.

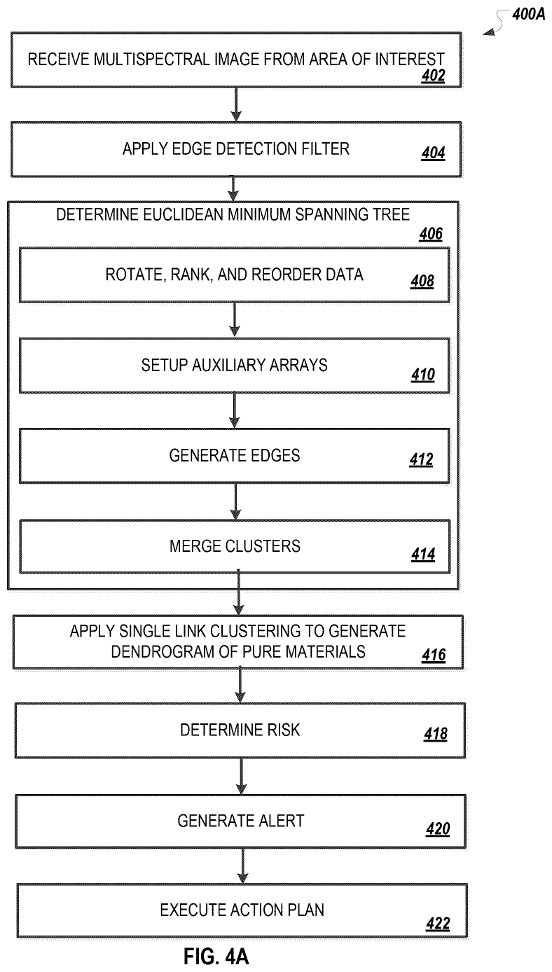

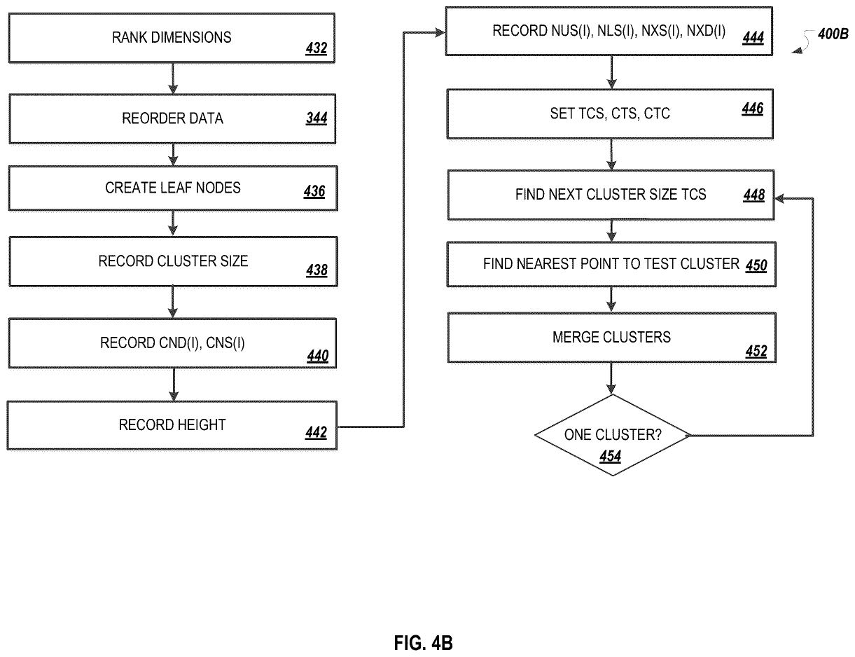

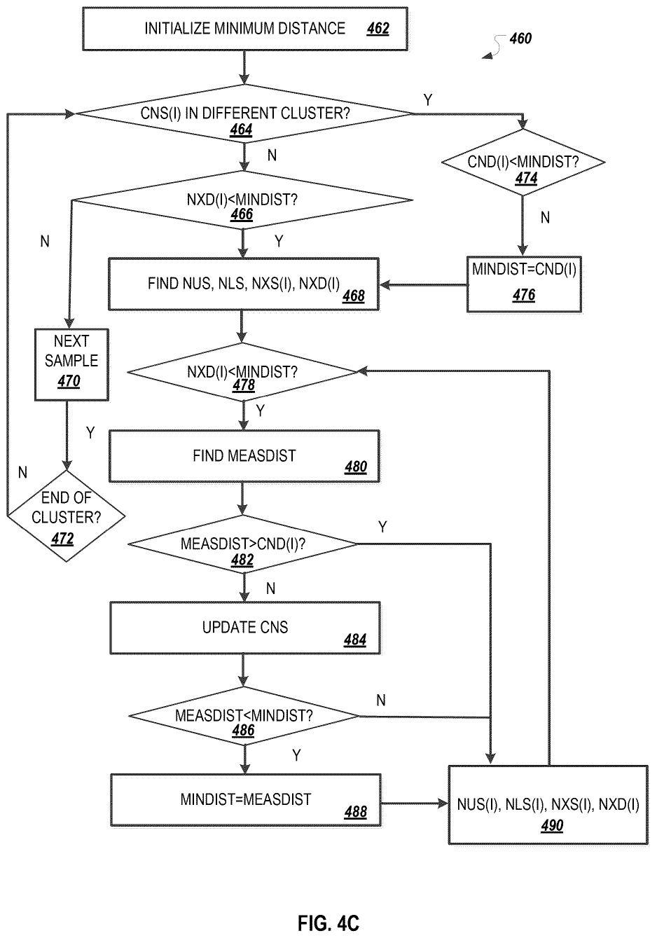

FIG. 3C illustrates an example single-link clustering 300C, according to some implementations of the present disclosure. Initially all points of the example single-link clustering 300C belong to their own cluster, (1), (2), (3), (4), (5) and (6) 304A, 304B, 304D-304G. Clusters (4) and (5) are the closest and are selected to be the first to merge with the smallest join height, as shown in the dendrogram 308A. The next closest clusters are (3) and (45) as (3) and (4) are the closest two points belonging to different clusters, so they merge to form cluster (345). (2) then merges with (345) to form (2345), then (6) merges with (2345) to form (23456) and finally (1) merges with (23456) to form the root cluster (123456), which contains all of the points. When applied to a hyperspectral image, the resulting dendrogram encodes the hierarchical structure of all the material spectra in the image, and each node in the dendrogram 308A corresponds to a cluster of materials. The calculation of the single-link clustering is described in detail with reference to FIGS. 4A-4C.

FIG. 4A depicts a flowchart illustrating an example process for clustering algorithms for unsupervised segmentation of multispectral images, in accordance with some example embodiments. Referring to FIGS. 1A and 1B, the process 400A can be performed by any components of the example system 100.

At 402, a multispectral image is received, by one or more processors, from a region of interest. The multispectral image can be received from a satellite, or an aerial device (e.g., aerial device 128 described with reference to FIG. 1A) equipped with a multispectral image acquisition device. A typical multi- or hyperspectral image (e.g., example multispectral image 200A) can have N=W*H pixels (with width W and height H), with each pixel having an associated spectrum consisting of C “channels” (or “bands”, or “dimensions”). The set of spectra associated with the pixels can be represented as vectors in a multi-dimensional (e.g., 12-dimensional, if C=12) space, where materials with similar spectra can form clusters of high density. The multispectral image can be processed to obtain one or two-dimensional cross sections showing the first two principal components of the C-dimensional spectral vector space. Every point in the scatterplot can corresponds to the spectrum of a vector associated with a pixel in the original multispectral image. The set of spectra associated with the pixels can be represented as a scatterplot including vectors in a C-dimensional space, where materials with similar spectra can form clusters of high density. Every point in the scatterplot corresponds to the spectrum of a vector associated with a pixel in the original image.

At 404, a multidimensional edge detection filter is applied, by the one or more processors. In order to mask out the “impure” pixels, an edge detection filter is first applied. Applying the edge detection filter can include a convolution with a 3×3 edge detection filter for detecting edges in grayscale images. The application of the edge detection filter can effectively measure the gradients Gₓ and G_{y} in the x- and y-directions respectively at each pixel, with the overall gradient measure for the pixel given by:

$$G = \sqrt{{G}_{x}^{2} + {G}_{y}^{2}}$$

The edge detection filter can be applied to a grayscale conversion of the multispectral image. The edge detection filter can include a Sobel filter or a Scharr filter. The 3×3 Scharr filter has a better rotational invariance than the Sobel filter. The Scharr filter can be the basis of the normalized multidimensional edge detection filter: The form of the Scharr filter for measurement of gradients in the x-direction is:

$${h}_{x}^{′} ( : , : ) = [ \begin{matrix}- 47 & 0 & 47 \\ - 162 & 0 & 162 \\ - 47 & 0 & 47\end{matrix} ]$$

The negative transpose of the filter is the Scharr filter in the y-direction. In order to apply Scharr filter to multi- and hyperspectral images, the x- and y-direction filters are both extended into a cuboid of length equal to the number C of bands in the image (e.g., 12 bands). Each 3×3 layer of the 3×3×C filters that result can contain the same values as above. In order for the resulting filter to be applied to the edge and corner pixels, linear interpolation can be used to extend the image by one pixel at the edges and corners for the top left corner of one band of the image. The linear interpolation can be done for all of the edge and corner pixels in all of the bands. Add a border around each band of the image by linearly interpolating the values by one pixel. The x- and y-direction Scharr filters can be applied band-by-band and pixel-by-pixel to the entire image to obtain G_{x[k]} and G_{y[k]} for each pixel where k denotes the band. For example, the formula for calculating G_{x[k]} by applying Gₓ to pixel (i,j) in band k of the image (where “I” is the x-coordinate “j” is the y-coordinate) is given by:

$${G}_{x [ k ]} = 47. * ( v [ i ] [ j ] [ k ] + v [ i ] [ j + 2 ] [ k ] - v [ i + 2 ] [ j ] [ k ] - v [ i + 2 ] [ j + 2 ] [ k ] ) + 162. * ( v [ i ] [ j + 1 ] [ k ] - v [ i + 2 ] [ j + 1 ] [ k ] ) ,$$

The term v [i][j][k] is the value of the pixel (i,j) in band k. The strength of the edge for a given pixels is then the square root of the sum over all bands of G_{x[k]} *G_{x[k]}+G_{y[k]}*G_{y[k]}. This can also be represented as a matrix convolution. The term G_{y[k]} is calculated for the pixel in band k in the same way, and the set of G_{x[k]} and G_{y[k]} over all bands is used to calculate the edge index G for the pixel (e.g., FIG. 2C shows the result of calculating the edge index for all pixels in the image). The process of masking out mixed pixels reduces the original S data samples/pixels to a portion (N) of samples that remain unmasked.

At 406, a Euclidean minimum spanning tree of unmasked samples is determined. The Euclidean minimum spanning tree (EMST) of the data samples is calculated using a single-link clustering, a “dendrogram”, which includes a binary tree encoding the hierarchy of clusters of the spectra in the image. The dendrogram is built up one branch at a time such that each pixel's spectrum is initially considered to belong to its own cluster. The “closest” two clusters are merged into a single cluster with the merging height or “join” height being the distance between them. In the case of single-link clustering, the distance between two clusters is the shortest distance between two points, one from each cluster. Other standard hierarchical clustering methods differ only in the way that the distance between clusters is measured. The merging process is repeated until only a single cluster remains. The result of single-link clustering can be encoded in a dendrogram.

Determining the Euclidean minimum spanning tree of unmasked can include rotating, ranking, and reordering data samples of the dendrogram 408, creating leaf nodes as the initial clusters 410, generating edges of the EMST 412, and identifying clusters for merging 414.

At 408, a principal component rotation is applied to the data samples before sorting the dimensions. The rotation does not change the resulting minimum spanning tree because applying a rotation does not affect the Euclidean distance between the sample points. The advantage of applying a principal components rotation is that it results in a smaller number of dimensions (e.g., a first portion of principal components) containing the bulk of the variability. The minimized dimensions can make the sorting of dimensions more effective both in reducing the number of distance measurements required and the average number of summations over dimensions required before aborting individual distance calculations when the distances are larger than the minimum distance being compared against. For sorting the dimensions, the interquartile range, in other words the range between the first and third quartiles and hence containing the middle 50% of the samples, is calculated for each of the C dimensions. The interquartile range is an advantageous measure, because it is minimally affected by stray samples at the extremes of the range and therefore gives a good representation of the variation for the majority of the samples. The dimensions of the sample array are reordered in order of decreasing interquartile range, or a ranking order of the dimensions is stored in a dimension rank array. The data samples are reordered within the array in one of two ways: 1) radial ordering: the samples are reordered in order of increasing distance from an origin, which is selected for example to be the sample with the smallest component in the dimension with the largest interquartile range; and 2) linear ordering: the samples are reordered in order of increasing value in a selected dimension (e.g., the dimension with the largest interquartile range). In both cases, the original index is stored in a one-dimensional array for identification of individual samples. Modifying the radial ordering can set the origin to the actual origin [0, 0, . . . , 0] rather than defining it for a specifically selected sample. For example, an array tree(i) can map the original pixel index of the sample to its new index according to the selected ordering, as well as an array pix(i) which performs the inverse mapping. The tree(i) array can become the mapping from the original pixel index to the corresponding position in the materials dendrogram. The construction of the materials dendrogram can be deferred until after the EMST has been calculated. Rather than repeatedly shuffling the locations of each sample in the dendrogram every time two clusters are merged, which is a time-consuming process, linked lists are used to keep track of the relative locations of the samples in the dendrogram without explicitly maintaining and updating a complete representation of the dendrogram itself. The location tracking avoids all of the shuffling of samples previously carried out, using traditional methods, to simultaneously generate the EMST and the single-link clustering dendrogram. Instead, the EMST is first calculated separately after which it is relatively straightforward to derive the results of single-link clustering and use the results of single-link clustering to generate the final materials dendrogram in a single sweep without array shuffling.

At 410, auxiliary arrays are setup. The auxiliary arrays include adjacent auxiliary array, last point auxiliary array, and cluster auxiliary array. The adjacent auxiliary array contains the index of the sample to the left of the i^{th} sample in the dendrogram that belongs to the same cluster. It is initialized to −1 as to indicate that initially there are no other samples in the same cluster. The last point auxiliary array contains the index of the last sample in the dendrogram that belongs to the i^{th} cluster. Note that initially, the i^{th} sample is the i^{th} cluster, so lastpoint(i)=i, initially. The next cluster auxiliary array is the next cluster after the i^{th} cluster in the dendrogram. The use of this and the next linked list is what avoids the need for reshuffling samples in the dendrogram after each merging of a pair of clusters. Initially nextclust (i)=i+1. Previous cluster is the previous cluster before the i^{th} cluster in the dendrogram. Initially prevclust (i)=i−1. Cluster size is number of samples in the i^{th} cluster, having an initial value of 1. The arrays are used to encode the information in the dendrogram.

At 412, edges of the EMST are generated one-by-one until all N−1 edges have been generated. It is important to note that these edges are not generated in order of increasing height, and thus the EMST algorithm does not a priori carry out the single-link clustering. The EMST algorithm generates all N−1 edges of the EMST one-by-one.

At 414, clusters are merged. For a given edge the sample with index i can belong to cluster k that is to be merged with the sample with index j, belonging to cluster m, with a merge distance relative to edge length h. An example merging process to update the above arrays according to the current implementations is as follows:

Let n, treepos (tree positions) be auxiliary variables.

If cluster k precedes cluster m in the tree:
Set source[m] to j.
Set dest[m] to i (indicating the pair of points closest at merging time).
Set height[m] to h.
Increase the size of cluster k by the size of cluster m.
   For each element n in cluster m:
   Set treepos to the position of the last point in cluster m.
   Update clust[treepos] to indicate it belongs to cluster k.
   Move treepos to the next adjacent point in the cluster.
Update the linkage of clusters:
   Set nextclust[prevclust[m]] to nextclust[m].
   If nextclust[m] is within bounds:
      Set prevclust[nextclust[m]] to prevclust[m].
Adjust the adjacency pointers:
   Set adjacent[m] to lastpoint[k].
   Set lastpoint[k] to lastpoint[m].
   Set nextclust[m] to nextclust[k].

Else (cluster m precedes cluster k in the tree):
Set source[k] to i.
Set dest[k] to j (indicating the pair of points closest at merging time).
Set height[k] to h.
Increase the size of cluster m by the size of cluster k.
For each element n in cluster k:
   Set treepos to the position of the last point in cluster k.
   Update clust[treepos] to indicate it belongs to cluster m.
   Move treepos to the next adjacent point in the cluster.
Update the linkage of clusters:
   Set nextclust[prevclust[k]] to nextclust[k].
   If nextclust[k] is within bounds:
      Set prevclust[nextclust[k]] to prevclust[k].
Adjust the adjacency pointers:
   Set adjacent[k] to lastpoint[m].
   Set lastpoint[m] to lastpoint[k].
   Set nextclust[k] to nextclust[m].

The described method ensures that the relative order of the clusters being merged is maintained in the representation of the dendrogram. In some implementations, the clusters are merged in such a way that the smaller cluster is always merged with the larger cluster, by swapping (i, k) with (j, m). The merging can result in a further modest speed up as the number of cluster reassignments of the samples can be reduced.

At 416, single-link clustering can be applied once all of the edges have been generated by reordering them in ascending order of edge length/merge height and then carrying out the cluster merges by merging the source and destination clusters associated with each edge to generate a dendrogram of pure materials. In order to create a dendrogram that is generated by single-link clustering of the data samples that encodes the materials hierarchy, the dendrogram is represented by the auxiliary arrays with the edges representing the cluster merges presented in ascending order of edge length, or equivalently, cluster merge height. To do this, the source(i), dest(i) and height(i) arrays generated by the EMST algorithm (where the i here indexes the clusters to be merged) are ranked and re-sorted in ascending order using the height array as key, with the results being stored in new arrays from(i), to(i) and afar(i) respectively, which directly encode the edges of the EMST in increasing order of edge length. The arrays from(i), to(i), and afar(i) can be used to generate the materials dendrogram by initializing the auxiliary arrays adjacent(i), lastpoint(i), nextclust(i), prevclust(i), clustsize(i), clust(i), modifying the way the clusters are numbered. In particular, each non-leaf node (or ‘branch’) in the dendrogram represents the cluster that contains all of the samples beneath it in the binary tree structure. The number associated with that cluster is defined to be the index of the sample that ‘joins’ to that node that in the tree. In addition to the array join(i) that encodes the locations of all of the branches in the dendrogram, convenience auxiliary arrays clust1size(i) and clust2size(i) are introduced, for which the size of the two clusters that merge to form cluster i is stored. Note that once the clustering has been completed, the arrays adjacent(i), join(i) and height(i) can contain all of the information necessary to represent the dendrogram. The arrays source(i), dest(i) and height(i) must be recalculated to reflect the new order of cluster merges and the corresponding nodes that are merged. The arrays are initialized as follows:

$$clust ( i ) = source ( i ) = dest ( i ) = join ( i ) = lastpoint ( i ) = i$$

$$clustsize ( i ) = clust 1 size ( i ) = clust 2 size ( i ) = 1$$

$$height ( i ) = infinity$$

$$adjacent ( i ) = - 1$$

$$nextclust ( i ) = i + 1$$

$$prevclust ( i ) = i - 1$$

For each of the N−1 edges in turn, indexed by e={1, 2, . . . , N−1}, the sample with index i=from(e), belonging to cluster k=clust(i) has to be merged with the sample with index j=to(e), belonging to cluster m=clust(j), with a merge distance/edge length h=afar(e). This is done by updating the arrays as follows:

Let n, treepos be auxiliary variables.

If cluster k precedes cluster m in the tree:
Set join[m] to k (indicating cluster k joins with cluster m).
Set source[m] to j (the pair of points closest at the time of merging).
Set dest[m] to i.
Set height[m] to h.
Set clust1size[m] to clustsize[k].
Set clust2size[m] to clustsize[m].
Increase the size of cluster k by the size of cluster m.
Set clustsize[m] to the new size of cluster k.
For each element n in cluster m:
   Set treepos to the position of the last point in cluster m.
   Update clust[treepos] to indicate it belongs to cluster k.
   Move treepos to the next adjacent point in the cluster.
Update the linkage of clusters:
   If nextclust[m] is within bounds:
      Set nextclust[clust[prevclust[m]]] to clust[nextclust[m]].
   Else:
      Set nextclust[clust[prevclust[m]]] to N+1 (e.g., out of bounds).
   If nextclust[m] is within bounds:
      Set prevclust[clust[nextclust[m]]] to clust[prevclust[m]].
Adjust the adjacency pointers:
   Set adjacent[m] to lastpoint[k].
   Set lastpoint[k] to lastpoint[m].
   Set nextclust[m] to clust[nextclust[k]].

Else (cluster m precedes cluster k in the tree):
Set join[k] to m (indicating cluster m joins with cluster k).
Set source[k] to i (the pair of points closest at the time of merging).
Set dest[k] to j.
Set height[k] to h.
Set clust1size[k] to clustsize[m].
Set clust2size[k] to clustsize[k].
Increase the size of cluster m by the size of cluster k.
Set clustsize[k] to the new size of cluster m.
For each element n in cluster k:
   Set treepos to the position of the last point in cluster k.
   Update clust[treepos] to indicate it belongs to cluster m.
   Move treepos to the next adjacent point in the cluster.
Update the linkage of clusters:
   If nextclust[k] is within bounds:
      Set nextclust[clust[prevclust[k]]] to clust[nextclust[k]].
   Else:
      Set nextclust[clust[prevclust[k]]] to N+1 (e.g., out of bounds).
   If nextclust[k] is within bounds:
      Set prevclust[clust[nextclust[k]]] to clust[prevclust[k]].
Adjust the adjacency pointers:
   Set adjacent[k] to lastpoint[m].
   Set lastpoint[m] to lastpoint[k].
   Set nextclust[k] to clust[nextclust[m]].

In some implementations, the clusters can be merged in such a way that the smaller cluster is always merged with the larger cluster, by swapping (i, k) with (j, m) where necessary. Once the above clustering process is complete, a single cluster remains that contains all of the samples. The order of the samples (e.g., of the leaf nodes) in the dendrogram can be extracted using the adjacent(i) array. In particular, the index i of the first sample in the dendrogram can be the one for which adjacent(i)=−1. The index j of the second sample can be the one for which adjacent(j)=i. An auxiliary array nextsamp(i) can be defined, which for each sample i, stores the index of the sample next to it in the dendrogram as follows:
Let nextsamp be a vector of size N.
Let firstpure be an integer variable.
For each index i from 1 to N:
   If adjacent[i] is equal to −1:
      Set firstpure to i (indicating the starting point for forward traversal along the tree).
   Else:
      Set nextsamp[adjacent[i]] to i.

The firstpure is the index of the sample that corresponds to the first leaf node in the dendrogram. The auxiliary array nextsamp(i) can be used to iteratively obtain the remaining samples. Another auxiliary array can be defined to replace(i) which indicates the correct position in the materials dendrogram of the sample with index i. The replace(i) array can be derived as follows:
Let replace be a vector of size N.
Let j be initialized to firstpure.
Set replace[j] to 1 (firstpure is the index of the first sample in the dendrogram).
For each index i from 2 to N:
   Set j to nextsamp[j] (get the index of the next sample in the dendrogram).
   Set replace[j] to i (save the position in the dendrogram of the next sample).

The array replace(i) is used to replace every occurrence of the sample index with its corresponding position in the dendrogram in each of the arrays join(i), height(i), source(i), dest(i), clustsize(i), clust1size(i), and clust2size(i). This is done as follows:
Let i_copy be a vector of integers of size N.
Let f_copy be a vector of floats of size N.
Set i_copy( ) equal to join( ).
For each index i from 1 to N:
   Set join[replace[i]] to replace[i_copy[i]].
Set f_copy( ) equal to height( ).
For each index i from 1 to N:
   Set height[replace[i]] to f_copy[i].
Set i_copy( ) equal to source( ).
For each index i from 1 to N:
   Set source [replace[i]] to replace[i_copy[i]].
Set i_copy( ) equal to dest( ).
For each index i from 1 to N:
   Set dest[replace[i]] to replace[i_copy[i]].
Set i_copy( ) equal to clustsize( ).
For each index i from 1 to N:
   Set clustsize[replace[i]] to i_copy[i].
Set i_copy( ) equal to clust1size( ).
For each index i from 1 to N:
   Set clust1size[replace[i]] to i_copy[i].
Set i_copy( ) equal to clust2size( ).
For each index i from 1 to N:
   Set clust2size[replace[i]] to i_copy[i].

The arrays tree(i) and pix(i) which map the original pixel index of each sample to its new ordering according to the selected reordering scheme (and vice versa) can be updated so that they map each pixel index to and from the corresponding position in the materials dendrogram/binary tree. This allows us to forget about the original reordering that was used as it is no longer required. The process to update tree(i) and pix(i) is as follows:
Set i_copy equal to pix.
For each index i from 1 to N:
   Set pix[replace[i]] to i_copy[i].
Set tree to pix.
For each index i from 1 to N:
   Set tree[pix[i]] to i.

The arrays tree(i) and pix(i) facilitate an easy switch between the image representation and dendrogram representation of the unmixed samples.

The dendrogram (or “binary tree” or simply “tree”) resulting from the hierarchical clustering of N samples has 2N−1 nodes, including N leaf nodes and N−1 branch nodes. The final results of the clustering procedure are saved in the following arrays:
tree(i)—the position in the dendrogram of the leaf node/tree position corresponding to the i^{th} data sample;
pix(i)—the index of the data sample corresponding to the i^{th} leaf node/tree position in the dendrogram;
join(i)—the data sample to which a sample i “joins” in the tree;
height(i)—the joining height with which data sample i joins to data sample join (i) in the tree;
source(i), dest(i)—when cluster j merges with cluster k to form cluster i in the tree, these are closest two samples, the first from cluster j and the second from cluster k;
clustsize (i)—the size of cluster i in the tree;
clust1size(i), clust2size(i)—when cluster j merges with cluster k to form cluster i in the tree, these are the sizes of cluster k and cluster j respectively, with cluster k being on the left and cluster j on the right.

At 418, a risk is determined, by the one or more processors. The risk can be determined by performing a temporal variation of materials over the region of interest. For example, changes in the material abundance in temporally separated images of the same region can be used for change detection, monitoring and object/materials tracking and material variation patterns. The temporal variation analysis can be applied to scan large regions either domestically or globally for large scale mapping, safety, and security.

At 420, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more cleaning machines or deactivation of one or more systems for safety and protection of an environment and an industrial plant). The surface equipment can be selected to match the characteristics of the material movement pattern and execute the intended material cleaning or removal operations. The trained machine learning models can be configured to operate in active mode, for material movement pattern identification, facilitating automatic action plan implementation. For example, the trained machine learning models can trigger an initiation of the action plan, and a modification of surface equipment operations based on most recent map of materials relative to the predicted material movement pattern.

At 422, the action plan is automatically executed by generating a trigger, by the one or more processors, to activate an operation of a system or a machine configured to perform a remedy operation (e.g., cleaning, filtering, or material removal operation).

The example process 400A facilitates optimization of accurate generation of material map. One of the greatest benefits of generation of an accurate material map is that it facilitates activation of automatic remedial machine actions to ensure continuous workflows and access to facilities. The example process 400A enhances a characterization of regions of interest, providing resource conservation opportunities by minimizing computing system requirements and optimization of monitorization of a large range of materials.

In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, material management associated with overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

FIG. 4B depicts a flowchart illustrating an example process 400B for calculation of the Euclidean minimum spanning tree, in accordance with some example embodiments. Referring to FIGS. 1A and 1B, the process 400B can be performed by any components of the example system 100.

At 432, dimensions of the clusters are ranked, by one or more processors. The dimensions include edge length. The interquartile range (e.g., a range between a first quartile and a third quartile) and hence containing the middle 50% of the samples, is calculated for each of the D dimensions of a masked array of N samples. The dimensions of the sample array are reordered in order of decreasing interquartile range, or a ranking order of the dimensions is stored in a dimension rank array.

At 434, data is reordered, by the one or more processors. The data samples are reordered within the array in one of two ways: 1) radial ordering: the samples are reordered in order of increasing distance from an origin, which is selected for example to be the sample with the smallest component in the dimension with the largest interquartile range; and 2) linear ordering: the samples are reordered in order of increasing value in a selected dimension (e.g., the dimension with the largest interquartile range). In both cases, the original index is stored in a one-dimensional array for identification of individual samples. Modifying the radial ordering can set the origin to the actual origin [0, 0, . . . , 0] rather than defining it for a specifically selected sample. For example, an array tree(i) can map the original pixel index of the sample to its new index according to the selected ordering, as well as an array pix(i) which performs the inverse mapping.

At 436, leaf nodes are created, by the one or more processors. Each leaf node corresponds to a single-sample cluster and can use the convention that the cluster number in this case is the sample index+N, where N is the total number of samples. Each non-leaf node in the binary tree corresponds to the cluster containing all of the samples (e.g., leaf nodes) beneath it, and is numbered according to the sample that ‘joins’ to it.

At 438, cluster size is determined, by the one or more processors, and recorded in a storage (e.g., database or cache). The cluster size is number of samples in a respective cluster, having an initial value of 1 that increases during the merging process.

At 440, a current nearest distance (CND(i)) and a current nearest sample (CNS(i)) are determined, by the one or more processors, and recorded in a storage (e.g., database or cache). The distance from each unmerged sample to the nearest sample in a different cluster is stored as a variable CND(i). The index of the nearest sample is stored as an integer CNS(i).

At 442, height is recorded, by the one or more processors. The distance of each unmerged sample to the cluster to which it is merged is stored as the ‘merge height’. Initial height value (before merging) is set as infinity (e.g., a maximum value).

At 444, next upper samples (NUS(i)), next lower′ samples (NLS(i)), next sample (NXS(i)), and next distance (NXD(i)) are recorded, by the one or more processors. The difference between the absolute distance of the sample and the absolute distance of the NUS(i), and the difference between the absolute distance of the sample and the absolute distance of the NLS(i) are calculated. The smaller of the two differences is stored as NXD(i) of the sample and the sample index of the next upper or next lower sample NUS(i), NLS(i) which gave the smaller of the two differences is stored as the NXS(i).

At 446, test cluster size (TCS), current test sample (CTS), and current test cluster (CTC) are set, by the one or more processors. The TCS can be initially set to 1. The CTS is set initially to sample index 1, and the current test cluster CTC is the cluster containing that sample (initially cluster 1).

At 448, next cluster size is identified, by the one or more processors. The clusters are examined in the order in which they appear in the binary tree to find the next cluster having a size equal to the test cluster size TCS.

At 450, a nearest point to a test cluster is identified, by the one or more processors. The nearest sample to the current test cluster not itself contained in the test cluster is found based on a distance between the nearest point and the cluster.

At 452, clusters are merged, by the one or more processors, using cluster labels indicative of the cluster height. The clusters are labeled to indicate the cluster to which each sample belongs. Each sample is initially considered to belong to its own cluster and hence the cluster label is initially the index number of the sample. The cluster merging is performed based on the cluster labels, having the higher value label being added to the cluster having the lower value label.

At 454, it is determined, by the one or more processors, whether a single cluster remained. In response to determining that multiple clusters remained, the example process 400B returns to 448, to identify next cluster size.

FIG. 4C depicts a flowchart illustrating an example process 400C for merging of clusters, in accordance with some example embodiments. Referring to FIGS. 1A and 1B, the process 400C can be performed by any components of the example system 100.

At 462, a minimum distance (MinDist) is initialized, by one or more processors, by setting a minimum distance MinDist as infinity (e.g., a maximum value).

At 464, it is determined whether CNS(i) is in a different cluster, by the one or more processors. If the current nearest sample CNS(i) is not a member of the current test cluster CTC(i), and if the current nearest distance CND(i) is less than the minimum distance MinDist, set the minimum distance MinDist to be the current nearest distance CND(i), store the current sample index as the ‘head’ and the current nearest sample CNS(i) as the ‘tail’. Otherwise, if the next distance NXD(i) is less than the minimum distance MinDist, update the current nearest sample CNS(i) and current nearest distance CND(i) by resetting the current nearest distance CND(i) to infinity.

At 466, it is determined, by the one or more processors, whether NXD(i) is smaller than a minimum distance.

At 468, in response to determining that the NXD(i) is smaller than a minimum distance, ‘next upper’ samples NUS(i), ‘next lower’ samples NLS(i), ‘next sample’ NXS(i), and ‘next distance NXD(i) are identified, by the one or more processors, as described with reference to FIG. 4B.

At 470, a next sample NXS(i) is identified, by the one or more processors.

At 472, it is determined, by the one or more processors, whether the end of cluster was found.

At 474, it is determined, by the one or more processors, whether CND(i) is smaller than minimum distance.

At 476, if it is determined that CND(i) is equal to or greater than minimum distance, the value of CND(i) is set to be equal to CND(i), by the one or more processors.

At 478, it is determined, by the one or more processors, whether NXD(i) is smaller than a minimum distance. If the next distance NXD(i) is not less than the minimum distance, return to step 13ab) with the next sample in the cluster as the current sample. The comparison is performed by measuring the component of the distance in each dimension in the order determined at step 1, squaring the value of that component, and adding the squared value to a sum of squared values. After each summing operation, the sum is compared with the square of the nearest distance CND(i), and if greater, then the operation proceeds to 480 without summing any more terms. This method of performing the comparison avoids unnecessary calculations and gives improved speed, particular if C is large.

At 480, a measured distance (MeasDist) is identified, by the one or more processors. The MeasDist is a measure of the distance from a current sample to a next sample NXS(i). If MeasDist is less than the nearest distance CND(i), update the nearest sample CNS(i) and the nearest distance CND(i) to be the next sample NXS(i) and MeasDist respectively. If furthermore MeasDist is less than MinDist, update MinDist to be MeasDist, store the current sample as the ‘head’ and the next sample NXS(i) as the ‘tail’.

At 482, it is determined, by the one or more processors, whether the MeasDist is greater than CND(i).

At 484, CNS is updated, by the one or more processors.

At 486, it is determined, by the one or more processors, whether the measured distance is smaller than a minimum distance.

At 488, in response to determining that the measured distance is smaller than the minimum distance, the measured distance is set to be equal to the minimum distance, by the one or more processors.

At 490, NUS, NLS, NXS(i), NXD(i) are identified, by the one or more processors. For example, the next upper or next lower sample NUS(i), NLS(i) are updated, according to whether the next sample NXS(i) was the next upper or next lower sample. If the next sample NXS(i) was the next upper sample NUS(i), then update the next upper sample NUS(i) to be the sample with the next higher leaf node index following the current next upper sample NUS(i) not in the test cluster. If the next sample NXS(i) was the next lower sample NLS(i), then update the next lower sample NLS(i) to be the sample with the next lower leaf node index before the current next lower sample NLS(i) not in the current test cluster. Recalculate the next sample NXS(i) and next distance NXD(i) taking into account the new next upper/lower sample NUS(i)/NLS(i).

In some implementations, any of processes 400A, 400B, 400C described with reference to FIGS. 4A, 4B, and 4C can include a cluster selection algorithm can optionally be applied to generate a library of key reference clusters or endmembers. Statistical models can be built of the clusters of interest. The clusters of interest can be used directly for materials classification or anomaly detection for example. Spectral unmixing can be applied to calculate the precise materials composition of the impure pixels, or any other spectra from images containing similar materials to the original image. Spectral unmixing can be used to identify anomalous or subpixel materials, or to constrain their spectra which can then be compared with a reference library of materials/endmembers. In particular, spectral unmixing can be used to detect and estimate the abundance of trace materials such as greenhouse gas emissions or pollutants whose spectra are known. Maps of material abundance over an image or region can be generated by applying spectral unmixing to the original image or other images in that region. Changes in the material abundance in temporally separated images of the same region can be used for change detection, monitoring and object/materials tracking. The temporal material differences can be applied to identify material movement patterns throughout large regions either domestically or globally for large scale mapping, intelligence and reconnaissance.

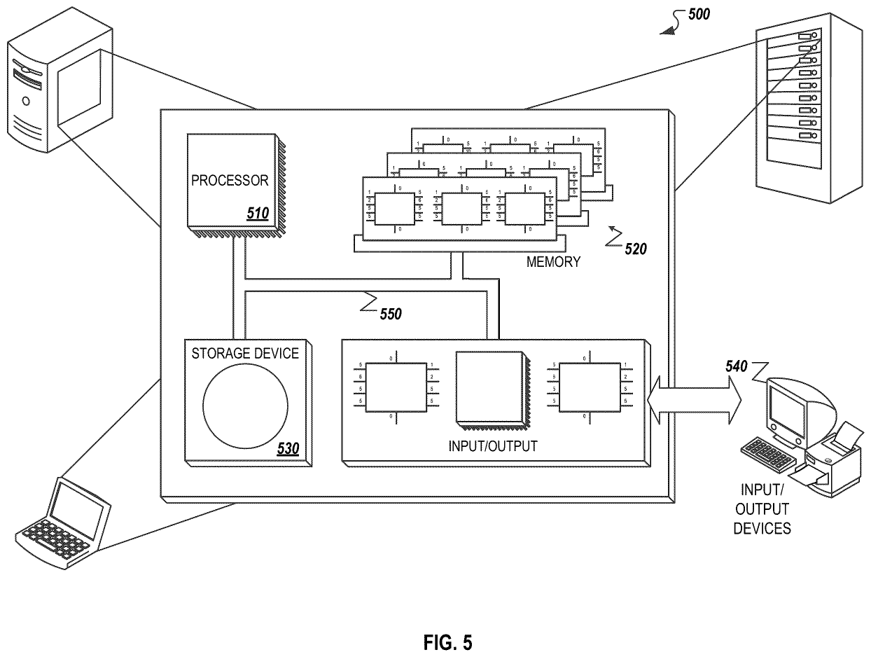

FIG. 5 depicts a block diagram illustrating a computing system 500, in accordance with some example embodiments. Referring to FIGS. 1A and 1B, the computing system 500 can be used to implement the server system 102 and/or any other components of the example system 100.

As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500. Such executed instructions can implement one or more components of, for example, the example system 100. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; and identifying an action plan to remedy a risk associated with the dendrogram of pure materials.

Example 2. The computer-implemented method of the preceding example, wherein each pixel of the plurality of pixels having an associated spectrum consisting of a plurality of dimensions.

Example 3. The computer-implemented method of any of the preceding examples, wherein determining the Euclidian minimum spanning tree of unmasked samples comprises: ranking the unmasked samples to generate ranked samples; reordering the ranked samples to generate reordered samples; storing locations of the reordered samples; iteratively finding the edges of the Euclidean minimum spanning tree of the reordered samples; and generating the dendrogram comprising the hierarchy of pure materials corresponding to the reordered samples.

Example 4. The computer-implemented method of any of the preceding examples, wherein reordering the ranked samples to generate the reordered samples comprises: radial ordering of the ranked samples in order of increasing distance from an origin.

Example 5. The computer-implemented method of any of the preceding examples, wherein reordering the ranked samples to generate the reordered samples comprises: linear ordering of the ranked samples in order of increasing value in a dimension.

Example 6. The computer-implemented method of any of the preceding examples, wherein determining the dendrogram of pure materials of unmasked samples comprises: setting up auxiliary arrays comprising an adjacent auxiliary array, a last point auxiliary array, and a cluster auxiliary array; and using the auxiliary arrays and the edges of the EMST ordered by increasing size to efficiently generate the dendrogram of pure materials.

Example 7. The computer-implemented method of any of the preceding examples, wherein identifying the action plan comprises: determining a material movement pattern from the dendrogram; determining a risk associated with a material movement pattern; and generating an alert indicative of the risk associated with the material movement pattern.

Example 8. The computer-implemented method of any of the preceding examples, wherein identifying the action plan comprises activating an equipment to clean or protect the one or more points of interests identified to be affected by the material movement pattern.

Example 9. A computer-implemented system comprising: memory storing application programming interface (API) information; and a server performing operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; and identifying an action plan to remedy a risk associated with the dendrogram of pure materials.

Example 10. The computer-implemented system of the preceding example, wherein each pixel of the plurality of pixels having an associated spectrum consisting of a plurality of dimensions.

Example 11. The computer-implemented system of any of the preceding examples, wherein determining the Euclidian minimum spanning tree of unmasked samples comprises: ranking the unmasked samples to generate ranked samples in order of increasing distance from an origin or in order of increasing value in a dimension; reordering the ranked samples to generate reordered samples; storing locations of the reordered samples; iteratively finding the edges of the Euclidean minimum spanning tree of the reordered samples; and generating the dendrogram comprising the hierarchy of pure materials corresponding to the reordered samples.

Example 12. The computer-implemented system of any of the preceding examples, wherein determining the dendrogram of pure materials of unmasked samples comprises: setting up auxiliary arrays comprising an adjacent auxiliary array, a last point auxiliary array, and a cluster auxiliary array; and using the auxiliary arrays and the edges of the EMST ordered by increasing size to efficiently generate the dendrogram of pure materials.

Example 13. The computer-implemented system of any of the preceding examples, wherein identifying the action plan comprises: determining a material movement pattern from the dendrogram; determining a risk associated with a material movement pattern; and generating an alert indicative of the risk associated with the material movement pattern.

Example 14. The computer-implemented system of any of the preceding examples, wherein identifying the action plan comprises activating an equipment to clean or protect the one or more points of interests identified to be affected by the material movement pattern.

Example 15. A non-transitory computer-readable media encoded with a computer program, the computer program comprising instructions that when executed by one or more computers cause the one or more computers to perform operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; and identifying an action plan to remedy a risk associated with the dendrogram of pure materials.

Example 16. The non-transitory computer-readable media of the preceding example, wherein each pixel of the plurality of pixels having an associated spectrum consisting of a plurality of dimensions.

Example 17. The non-transitory computer-readable media of any of the preceding examples, wherein determining the Euclidian minimum spanning tree of unmasked samples comprises: ranking the unmasked samples to generate ranked samples in order of increasing distance from an origin or in order of increasing value in a dimension; reordering the ranked samples to generate reordered samples; storing locations of the reordered samples; iteratively finding the edges of the Euclidean minimum spanning tree of the reordered samples; and generating the dendrogram comprising the hierarchy of pure materials corresponding to the reordered samples.

Example 18. The non-transitory computer-readable media of any of the preceding examples, wherein determining the dendrogram of pure materials of unmasked samples comprises: setting up auxiliary arrays comprising an adjacent auxiliary array, a last point auxiliary array, and a cluster auxiliary array; and using the auxiliary arrays and the edges of the EMST ordered by increasing size to efficiently generate the dendrogram of pure materials.

Example 19. The non-transitory computer-readable media of any of the preceding examples, wherein identifying the action plan comprises: determining a material movement pattern from the dendrogram; determining a risk associated with a material movement pattern; and generating an alert indicative of the risk associated with the material movement pattern.

Example 20. The non-transitory computer-readable media of any of the preceding examples, wherein identifying the action plan comprises activating an equipment to clean or protect the one or more points of interests identified to be affected by the material movement pattern.

What is claimed is:

1. A computer-implemented method comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials; and
identifying an action plan to remedy a risk associated with the dendrogram of pure materials.

2. The computer-implemented method of claim 1, wherein each pixel of the plurality of pixels having an associated spectrum consisting of a plurality of dimensions.

3. The computer-implemented method of claim 1, wherein determining the Euclidian minimum spanning tree of unmasked samples comprises:
ranking the unmasked samples to generate ranked samples;
reordering the ranked samples to generate reordered samples;
storing locations of the reordered samples;
iteratively finding the edges of the Euclidean minimum spanning tree of the reordered samples; and
generating the dendrogram comprising the hierarchy of pure materials corresponding to the reordered samples.

4. The computer-implemented method of claim 3, wherein reordering the ranked samples to generate the reordered samples comprises:
radial ordering of the ranked samples in order of increasing distance from an origin.

5. The computer-implemented method of claim 3, wherein reordering the ranked samples to generate the reordered samples comprises:
linear ordering of the ranked samples in order of increasing value in a dimension.

6. The computer-implemented method of claim 3, wherein determining the dendrogram of pure materials of unmasked samples comprises:
setting up auxiliary arrays comprising an adjacent auxiliary array, a last point auxiliary array, and a cluster auxiliary array; and
using the auxiliary arrays and the edges of the EMST ordered by increasing size to efficiently generate the dendrogram of pure materials.

7. The computer-implemented method of claim 1, wherein identifying the action plan comprises:
determining a material movement pattern from the dendrogram;
determining a risk associated with a material movement pattern; and
generating an alert indicative of the risk associated with the material movement pattern.

8. The computer-implemented method of claim 7, wherein identifying the action plan comprises activating an equipment to clean or protect the one or more points of interests identified to be affected by the material movement pattern.

9. A computer-implemented system comprising:
memory storing application programming interface (API) information; and
a server performing operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials; and
identifying an action plan to remedy a risk associated with the dendrogram of pure materials.

10. The computer-implemented system of claim 9, wherein each pixel of the plurality of pixels having an associated spectrum consisting of a plurality of dimensions.

11. The computer-implemented system of claim 9, wherein determining the Euclidian minimum spanning tree of unmasked samples comprises:
ranking the unmasked samples to generate ranked samples in order of increasing distance from an origin or in order of increasing value in a dimension;
reordering the ranked samples to generate reordered samples;
storing locations of the reordered samples;
iteratively finding the edges of the Euclidean minimum spanning tree of the reordered samples; and
generating the dendrogram comprising the hierarchy of pure materials corresponding to the reordered samples.

12. The computer-implemented system of claim 11, wherein determining the dendrogram of pure materials of unmasked samples comprises:
setting up auxiliary arrays comprising an adjacent auxiliary array, a last point auxiliary array, and a cluster auxiliary array; and
using the auxiliary arrays and the edges of the EMST ordered by increasing size to efficiently generate the dendrogram of pure materials.

13. The computer-implemented system of claim 9, wherein identifying the action plan comprises:
determining a material movement pattern from the dendrogram;
determining a risk associated with a material movement pattern; and
generating an alert indicative of the risk associated with the material movement pattern.

14. The computer-implemented system of claim 13, wherein identifying the action plan comprises activating an equipment to clean or protect the one or more points of interests identified to be affected by the material movement pattern.

15. A non-transitory computer-readable media encoded with a computer program, the computer program comprising instructions that when executed by one or more computers cause the one or more computers to perform operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials; and
identifying an action plan to remedy a risk associated with the dendrogram of pure materials.

16. The non-transitory computer-readable media of claim 15, wherein each pixel of the plurality of pixels having an associated spectrum consisting of a plurality of dimensions.

17. The non-transitory computer-readable media of claim 15, wherein determining the Euclidian minimum spanning tree of unmasked samples comprises:
ranking the unmasked samples to generate ranked samples in order of increasing distance from an origin or in order of increasing value in a dimension;
reordering the ranked samples to generate reordered samples;
storing locations of the reordered samples;
iteratively finding the edges of the Euclidean minimum spanning tree of the reordered samples; and
generating the dendrogram comprising the hierarchy of pure materials corresponding to the reordered samples.

18. The non-transitory computer-readable media of claim 17, wherein determining the dendrogram of pure materials of unmasked samples comprises:
setting up auxiliary arrays comprising an adjacent auxiliary array, a last point auxiliary array, and a cluster auxiliary array; and
using the auxiliary arrays and the edges of the EMST ordered by increasing size to efficiently generate the dendrogram of pure materials.

19. The non-transitory computer-readable media of claim 15, wherein identifying the action plan comprises:
determining a material movement pattern from the dendrogram;
determining a risk associated with a material movement pattern; and
generating an alert indicative of the risk associated with the material movement pattern.

20. The non-transitory computer-readable media of claim 19, wherein identifying the action plan comprises activating an equipment to clean or protect the one or more points of interests identified to be affected by the material movement pattern.
